(19) United States
(12) Patent Application Publication
(10) Pub. No.: US 2015/0197311 A1
(43) Pub. Date: Jul. 16, 2015

(54) Foot-sliding quad vehicle with tilt-grip steering

(71) Applicant: Nathan Wayne Entrekin, Mesa, AZ (US)

(72) Inventor: Nathan Wayne Entrekin, Mesa, AZ (US)

(21) Appl. No.: 14/598,237

(22) Filed: Jan. 16, 2015

Related U.S. Application Data
(60) Provisional application No. 61/964,858, filed on Jan. 16, 2014.

(51) Int. Cl. B62M 1/36

(52) U.S. Cl. CPC B62M 1/36

(57) ABSTRACT

A foot-sliding quad vehicle with tilt-grip steering includes two foot platforms secured to a sturdy four-wheeled frame and user-centric handle bars and grips. This breakaway human-powered, multi-geared craft takes advantage of the natural standing position, allowing back-and-forth thrusts to create forward vehicle propulsion in a stable and balanced environment. Compared with its cycling predecessors, it offers an innovative riding experience, with a higher degree of universality with age- and size-independent features, such as adjustable feet binders, flexible range-of-motion sliding, and variable handle positions. Whether for recreation, fitness, or transportation, riders will also appreciate customizable elements and exciting new embodiments of the present invention.

### CROSS-REFERENCE TO RELATED APPLICATIONS

This non-provisional application claims the benefit of the earlier filed U.S. Provisional Patent Application No. 61/964,858 filed Jan. 16, 2014 and entitled “A four-wheeled, human-powered, foot-sliding vehicle with vertical tilt-steering.”

### FIELD OF THE PRESENT INVENTION

Embodiments of this present invention are generally related to mobile fitness products, which can utilize certain bicycle components or those of other industries. More specifically, embodiments are related to human-powered, four-wheeled vehicles which are propelled by foot-sliding movements and steered by laterally-sweeping rotational handle grips secured upon vertical handle bars.

### BACKGROUND OF THE INVENTION

Human-powered vehicles of the bicycle, scooter, and similar orders may suffer from a stigma of being unsafe over certain terrains, being confined to, or hunched over on seats, and not utilizing the full capacity of the human core in motion, not to mention being fundamentally unbalanced, of themselves. They require balancing and stability skills which can be frustrating and dangerous for some people. Even three-wheeled vehicles pose a risk of tipping in some instances. Especially in rougher terrain or unstable surfaces, they may suffer instability, sinkage, slippage, and lack of performance. People may also experience certain discomforts from the seated position or specific back, leg, ankle, or foot issues from typical repetitive bicycling motions. Traditional cycling targets certain areas of the body that, over time, may potentially lead to chronic overexposure or medical traumas. Specific chronic fatigues may occur over time due to the position and motions required of the spine and body; moreover, the static design of bicycle frames and parts can clash with human factors (i.e. height, size, etc.), requiring problematic adjustments (seats, etc.) or costly customization.

Additionally, people of different heights and sizes waste time, energy, and money wrangling with bicycle seat adjustments or handle bar refitting, especially when sharing bicycles. The additional hassle of kickstands or finding places to prop bikes aright or ensure they do not fall can be problematic. And while riding on bicycles, the feet can often be brought into some fairly hazardous predicaments, with toe stubbing along uneven surfaces, encounters with thorny brush or tree stumps, and can even slip right off the pedals in some cases.

For all of the complications and needs mentioned above, human-powered vehicle enthusiasts stand to benefit from a stable, safe, sturdy, fun, challenging, and rewarding innovation in the recreation, transportation, and fitness worlds.

As is known, a more famous track sliding apparatus, used in the fitness world, comes close to the foot and leg motions of the present invention, however, it is obviously outdated and outmoded, being inherently stationary. And presently available quadricycles do not take advantage of sliding for propulsion, let alone offer a native standing posture, in their designs. The most similar designs are apparently found on two-wheeled and three-wheeled versions, where feet interaction are mechanically and ultimately tied to the cycling motion of the vehicle in some manner.

U.S. Pat. No. 8,764,040 discloses a quadricycle with standard bicycle-prone seat, handle bars, pedals, a unique drivetrain system, and a unique suspension system which permits leaning into turns, the latter being a relatively newer concept for human-powered quads.

U.S. Pat. No. 8,632,088 discloses a tricycle with two front wheels and a rear wheel, allowing for standing up on pedals in a cycling motion, during vehicle movement.

There are many pedal-powered scooters, but of course, they are comprised primarily of only two wheels and mostly do not boast a fully-geared drivetrain, lacking the desired stability and performance aspects. Thus, it is desirable to provide a four-wheeled vehicle allowing a rider to stand and engage in propulsion, via sliding leg motions, while secured with adjustable handle grips that rise up vertically to meet the hands at the sides.

And as most cycle-based handle bars fall short of the need for a back-and-forth sliding human body to remain purposefully and innately at a forward-facing inclination, it is further desirable to provide the aforementioned handle grips in such a configuration as to allow for intuitive steering via rotation, at convenient grip axes. Additionally, it is useful to incorporate this “tilt-grip” steering with brake levers, gear shifters, and accessory buttons, the latter of which provide more customization and functionality to the vehicle, such as rotational positioning control of the handle bars and/or a braking “hold-and-release” mechanism. Such a mechanism can allow for safe mounting and dismounting at the foot platforms of the present invention, as well as safe slowing and/or stopping during travel, such that all four wheels and sliding actions receive simultaneous braking when needed.

It is further desirable to expand on useful overall customizations and innovative embodiments of the present invention, such as the incorporation of an adjustable/removable seat or bench to the vehicle or different versions produced to handle various climates, terrains, or conditions.

### SUMMARY OF THE INVENTION

The present invention is a four-wheeled, human-powered vehicle, with an exclusive foot-sliding drivetrain and a handle-grip-centric steering system, all operated in the standing position. It offers an exciting and eco-friendly alternative to traditional cycling in the realms of fitness, recreation, and transportation. As visualized in the included drawings, it allows for standing and sliding, using forward and backward leg and foot strokes, in order to propel forward while navigating with custom handle grips. This innovative concept will carve new paths in unchartered territory outside the confines of the traditional cycling world.

The present invention provides more stability, balance, and a way to actively engage the standing position through natural sliding motion, alleviating bicycle-fatigued body parts. Riders are more fully betrothed to stimulating different postures and motions, targeting a fuller core body exercise experience. With easily-adjustable accessories and nearly unlimited customizations, this “almost” one-size-fits-all, geared vehicle can also move as quickly as traditional 10-speed bicycles.

Taking advantage of independent suspension at all four wheels, the frame assembly supports the standing weight of most riders, secured on foot platforms, via adjustable shoe binders. Just as 10-speed bicycles allow for freed backward spinning, during forward movement, the presently disclosed invention reverses the action, allowing free-spinning (disengaged) forward motion over frame-affixed sprockets, while engaging in backward thrusts to cause forward vehicle propulsion. This is done by incorporating two independent free hub sprockets on both sides which engage or disengage appropriately. Thus, one foot moving backward engages the drive chain, via the front drive chain component, while the other foot disengages and freely moves forward. At the same time, steering, braking, gear-shifting, and general upper-body stability takes place at the handle bars. The user affects steering in the desired directions via rotating “tilt-grip” handles, and with dynamic handle bar shafts locked into position, at the sides, general stability is provided throughout vehicle movement.

The position of the feet in relation to the ground, compared with bicycles, provides for excellent protection against rocks, brush, thorns, unexpected drops in ground level, and many other potential hazards. Not only this, but the rider is assured of independent suspension on four wheels, giving a solid response to many of the terrains and conditions that bicycles could only dream to handle. Furthermore, the brake system provides not only slowing and/or stopping of all four wheels, but also the actual sliding motion at the feet as well Additionally, it will take full advantage of traditional gear cassettes of bicycles and should be able to attain those particular speeds as desired. The major implementation of bicycle components in the present invention is also beneficial when maintenance, repairs, and replacement needs arise.

In addition to bringing a whole new breath to recreation and fitness, this quad vehicle opens a wide gamut of usage in transportation, offering an environmentally conscious mode of travel virtually anywhere.

### BRIEF DESCRIPTION OF THE DRAWINGS

For a more comprehensive understanding of the subject present invention, as alluded to in the present disclosure and its aforementioned aspects, reference is now made to the following brief description, taken in connection with accompanying drawings and detailed description, wherein like reference characters represent like elements. It is to be noted, however, that the appended drawings illustrate only typical embodiments of this present invention and are therefore not to be considered limiting of its scope, for the present invention may admit to other equally effective embodiments.

FIG. 1 is an oblique top view of the foot-sliding quad vehicle with tilt-grip steering, according to one embodiment of the present invention and its disclosure.

FIG. 2 is an orthogonal side view of the foot-sliding quad vehicle with tilt-grip steering of FIG. 1.

FIG. 3 is an orthogonal front view of the foot-sliding quad vehicle with tilt-grip steering of FIG. 1.

FIG. 4 is an orthogonal top view of the foot-sliding quad vehicle with tilt-grip steering of FIG. 1.

FIG. 5 is an oblique bottom view of the foot-sliding quad vehicle with tilt-grip steering of FIG. 1.

FIG. 6 is an oblique side view showing the tire/wheel assembly, one version as a whole (left side) and another of an exploded view (right side), of the foot-sliding quad vehicle with tilt-grip steering of FIG. 1.

FIG. 7 is a partially exploded oblique side view, with an orthogonal top view, of the steering rod tensioner assembly of the foot-sliding quad vehicle with tilt-grip steering of FIG. 1.

FIG. 8 is an oblique side view of the handle bar and grip assembly, along with an orthogonal front view of the working top portion of the handle bar and grip assembly, of the foot-sliding quad vehicle with tilt-grip steering of FIG. 1.

FIG. 9 is an oblique side view of the main chain assembly of the foot-sliding quad vehicle with tilt-grip steering of FIG. 1.

FIG. 10 is an oblique top view of the handle grip with its working components, according to the handle bar and grip assembly of FIG. 8.

FIG. 11 is an oblique side view of the foot platform assembly of the foot-sliding quad vehicle with tilt-grip steering of FIG. 1.

FIG. 12 is an oblique front view close-up of the foot platform assembly of FIG. 11.

FIG. 13 is an oblique back view close-up of the foot platform assembly of FIG. 11.

FIG. 14 is an exploded oblique side view, into three component groups, of the foot platform assembly of FIG. 11.

FIG. 15 is an oblique front view of the frame assembly of the foot-sliding quad vehicle with tilt-grip steering of FIG. 1.

FIG. 16 is an exploded oblique top view of the frame assembly of the foot-sliding quad vehicle with tilt-grip steering of FIG. 1.

FIG. 17 is an exploded orthogonal top view of the frame assembly of the foot-sliding quad vehicle with tilt-grip steering of FIG. 1.

FIG. 18 is an oblique front view of an alternative embodiment of the foot-sliding quad vehicle with tilt-grip steering of FIG. 1, which discloses a different system of power transfer, including (but not limited to) revised foot platform assemblies, a revised frame, and revised engagement sprockets system.

FIG. 19 is an oblique back view of the revised foot platform assembly, representing both right and left sides, of FIG. 18.

FIG. 20 is an oblique side view of the revised engagement sprockets system of FIG. 18.

FIG. 21 is an oblique top view of an alternative embodiment of the foot-sliding quad vehicle with tilt-grip steering of FIG. 1, which discloses a different system of power transfer, including (but not limited to) revised foot platform assemblies, a revised frame, and revised engagement sprockets system.

FIG. 22 is an oblique bottom view of the revised engagement sprockets system of FIG. 21.

FIG. 23 is an oblique front view of the revised foot platform assembly, representing both right and left sides, of FIG. 21.

### DETAILED DESCRIPTION

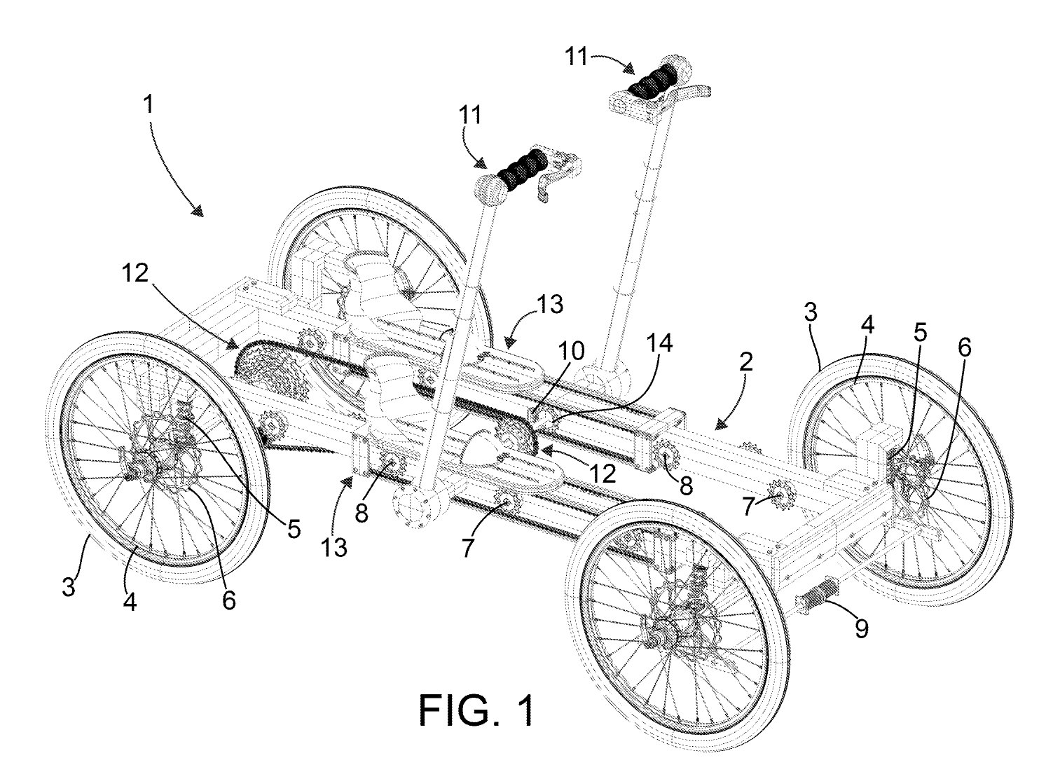

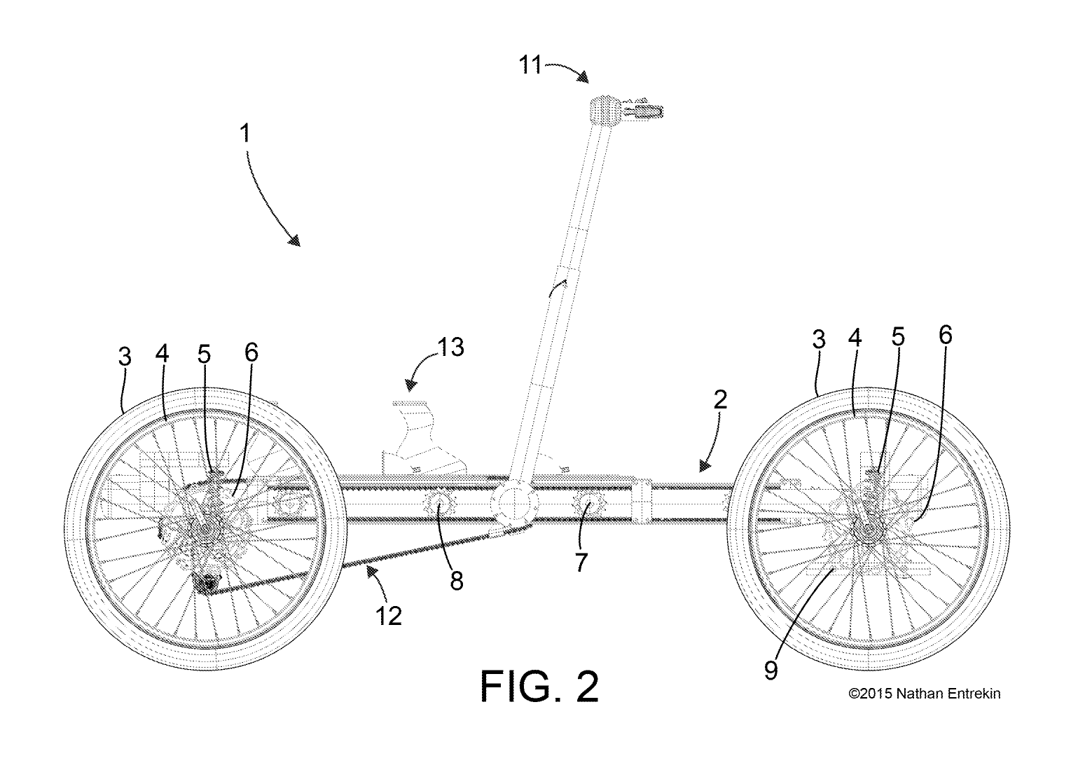

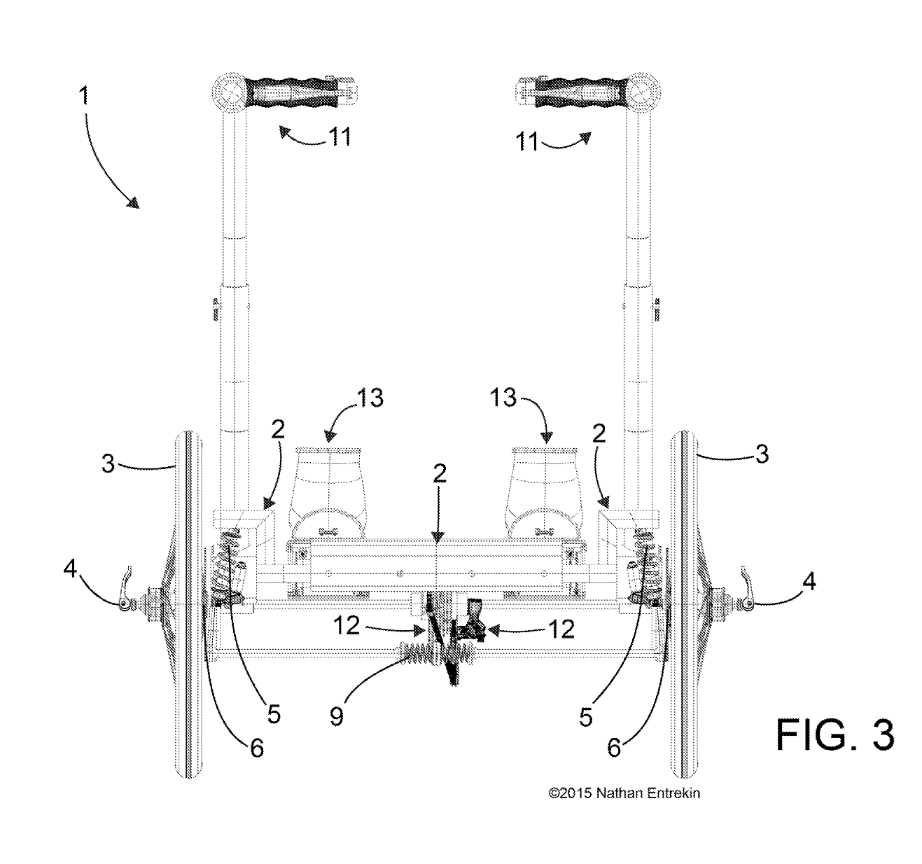

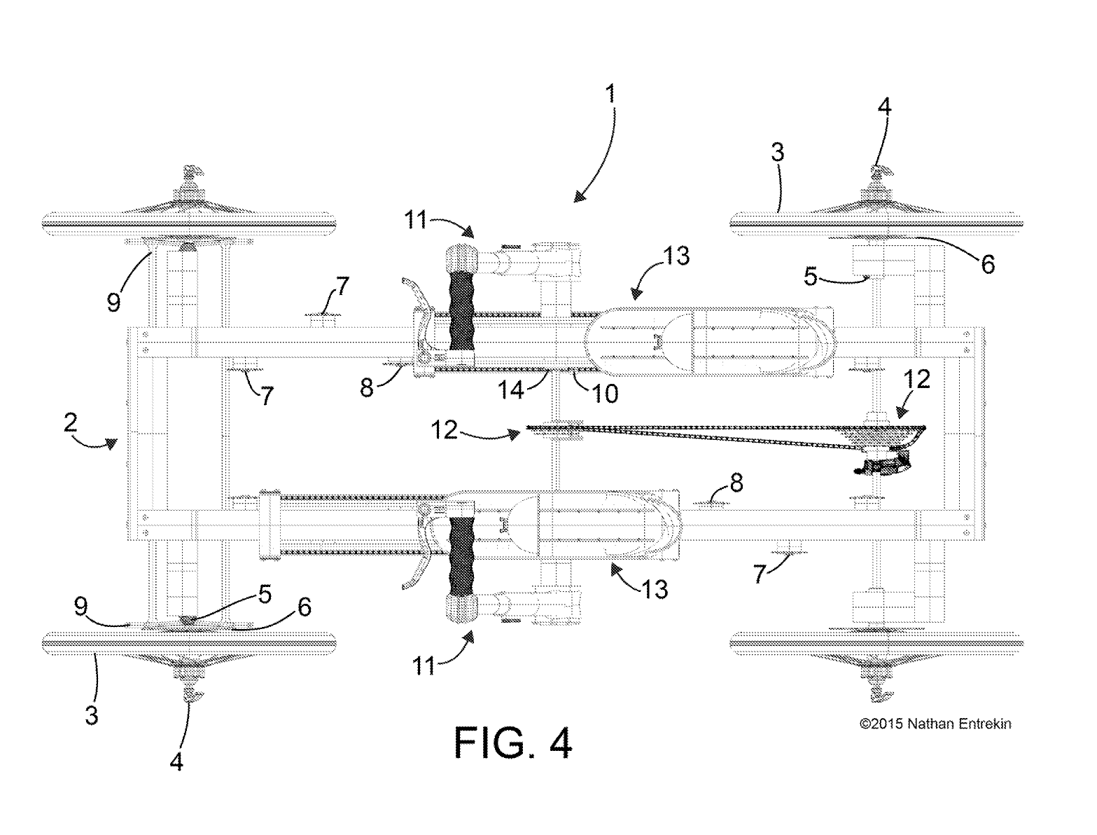

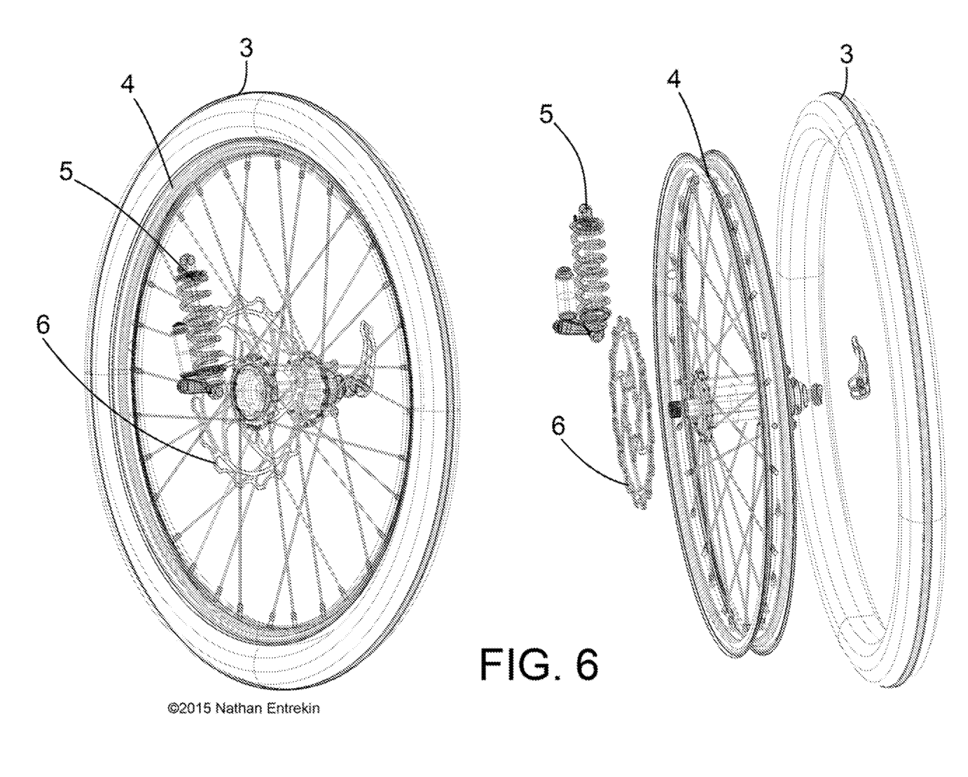

Referring to FIGS. 1-5, a foot-sliding quad vehicle with tilt-grip steering 1 is shown. The foot-sliding quad vehicle with tilt-grip steering 1 includes a frame assembly 2. The frame assembly 2, accommodating the width of an average adult human standing at the squared frame tubing, houses eighteen sprockets, fastened via welded posts and running lengthwise along the frame, sixteen of which are free-spinning and two of which are bicycle-grade 10-speed engagement sprockets 14. Beginning at the midpoints of both inner sides of the frame are housed the engagement sprockets 14, with their respective sprocket brake calipers 10, which in turn, are attached to the frame and provide slowing and/or stopping power to the foot platform assembly 13 above, at both sides. Distributed evenly and going out from the center of both engagement sprockets 14, are housed, first in order, free-spinning sprockets 8, and then, free-spinning sprockets 7. The difference in these two types of free-spinning sprockets is their individual base heights, which allow for interaction with “chain sticks” housed inside each of the two foot platform assemblies 13. Placed running along the outside of the frame, equidistantly between each of the ten aforementioned sprockets (five per inner side), are also free-spinning sprockets. The order of placement on the right outer side, moving out from the midpoint toward the rear, is free-spinning sprockets 8 and 7; while, from the midpoint toward the front, is placed free-spinning sprockets 7 and 8. Conversely, the order of placement on the left outer side, moving out from the midpoint toward the rear, is free-spinning sprockets 7 and 8; while, from the midpoint toward the front, is placed free-spinning sprockets 8 and 7. Secured to the frame assembly 2, lengthwise at the midpoints of both sides, are handle bar and grip assemblies 11. The frame assembly 2, rectangular in shape, has four custom-shaped suspension columns, joined at the relatively distal front and back endpoints, and made to ultimately connect and support all four wheels of the foot-sliding quad vehicle with tilt-grip steering 1. At each of the two suspension columns in the front are affixed a shock absorber 5, which connects from the ceiling of the columns down to a connection with the steering rod assembly 9, a brake disc 6, and the wheel 4 and tire 3. Likewise, at each of the two suspension columns in the rear of the vehicle are affixed a shock absorber 5, which connects from the ceiling of the columns down to an axle connection, which in turn, leads to a brake disc 6, and the wheel 4 and tire 3. Refer to FIG. 6 for a close-up view of the tire and wheel assembly, with parts, as mentioned. For the purpose of this disclosure, all four tires/wheels, are between 12″-16″ in size, and their constituent parts, such as inner tubes, spokes, air valves, etc., are to be of high-quality bicycle manufacture. For purposes of expediency, any mention of “wheel” or “wheels,” throughout this disclosure, unless otherwise indicated, should refer to the whole representation as indicated by the drawing on the left side in FIG. 6, and its disclosed implementations as seen in FIG. 1-5. The foot platform assembly 13, placed at the right and left feet, runs freely back and forth along the lengthwise sides of the frame assembly 2. All four chain sticks, contained within each of the foot platform assemblies 13, run over or under their respectively-positioned free-spinning sprockets 7 and 8. Additionally, the bottom-most inner-side chain stick runs underneath the engagement sprockets 14, in both engagement and free-spinning actions, via connection of an axle, with the main chain assembly 12. From the aforementioned axle and its constituent parts, namely a front sprocket cassette and derailleur system, the connected chain runs back to the rear sprocket cassette and derailleur system. As each foot platform assembly 13 slides backwards, the engagement sprockets 14 roll forward, independent of each other, causing the chain, connected at the middle of the main chain assembly 12, to spin around in the forward motion. This concurrently produces forward propulsion, as the chain connects with the rear sprocket cassette in the back, turning the rear wheels through the rear axle connection.

It is noted in this disclosure that some potentially or fully expected components are not showing at all in any of the supplied drawings, including, but not limited to: cables (i.e. steering cables, brake disc cables, etc.), connectors, brake disc components (i.e. disc calipers, etc.), axles, bolts, nuts, screws, and/or any element deemed required or suggested for the present invention to operate safely, securely, soundly, adequately, effectively, and efficiently. It is noted that the present invention seeks parts and components of high-quality manufacture for all regions of the foot-sliding quad vehicle with tilt-grip steering 1, as given in the disclosure. It is also noted that, at any point in the fruition and realization of this present invention, whether in manufacturing or otherwise, any and/or all of the aforementioned parts, elements, or components of this disclosure, including any and all materials (i.e. metals, alloys, plastics, composites, etc.), including the methods which are employed at any stage, are subject to change as to their type, placement, function, and/or purpose throughout this present invention. Hence, the disclosure of the present invention plainly and presently places emphasis on the conceptual nature of the foot-sliding quad vehicle with tilt-grip steering 1, and not so much on every single detail of each component or element or function or method brought to bear throughout the disclosure or in future embodiments. It should not be construed, however, that any such concepts, in any form or embodiment throughout this disclosure, as are brought to bear herein, allow for any outside infringements or plagiarisms, according to any perceived lack of detail or any other reason, following the given descriptions and drawings of this present invention.

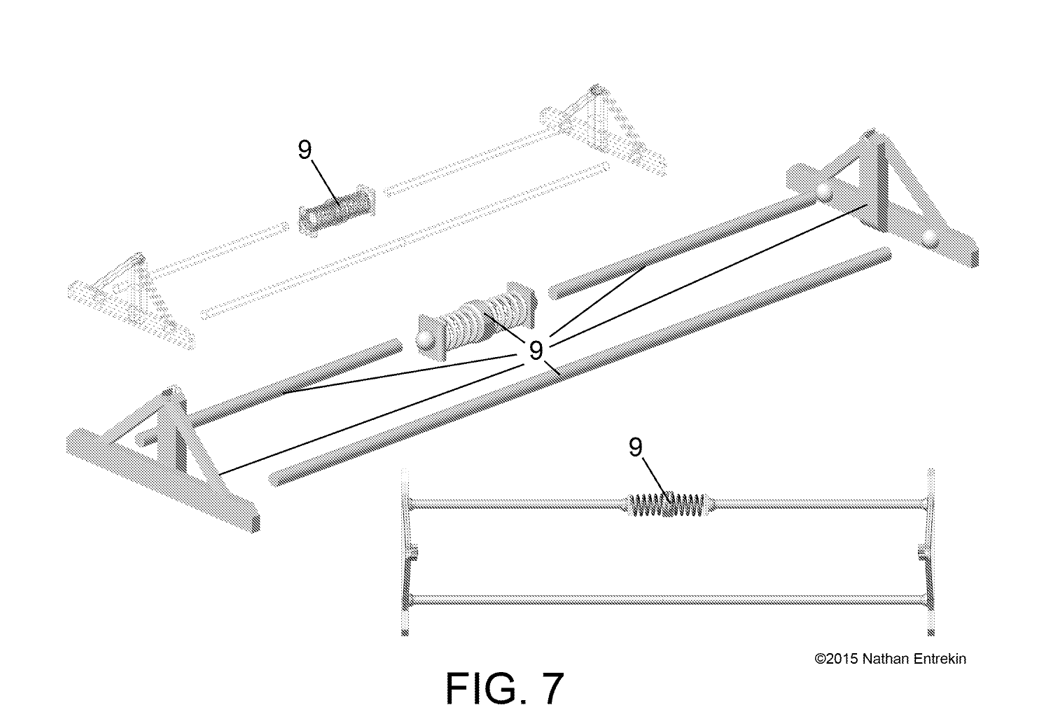

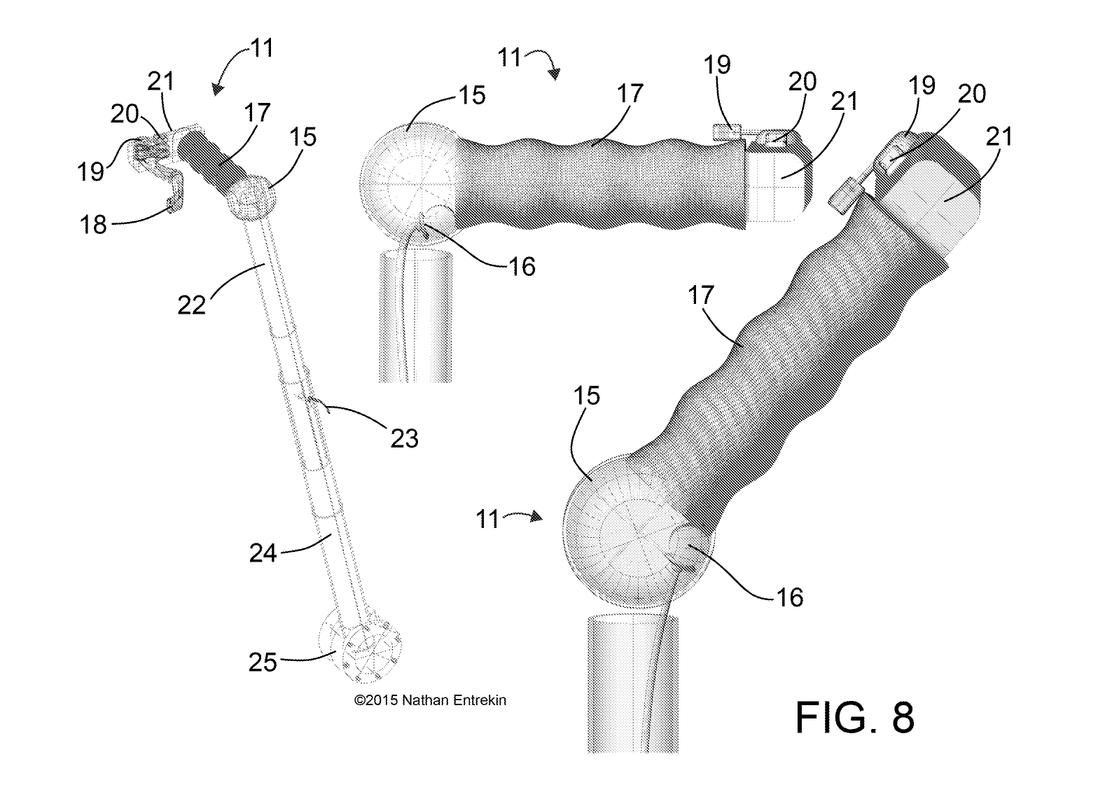

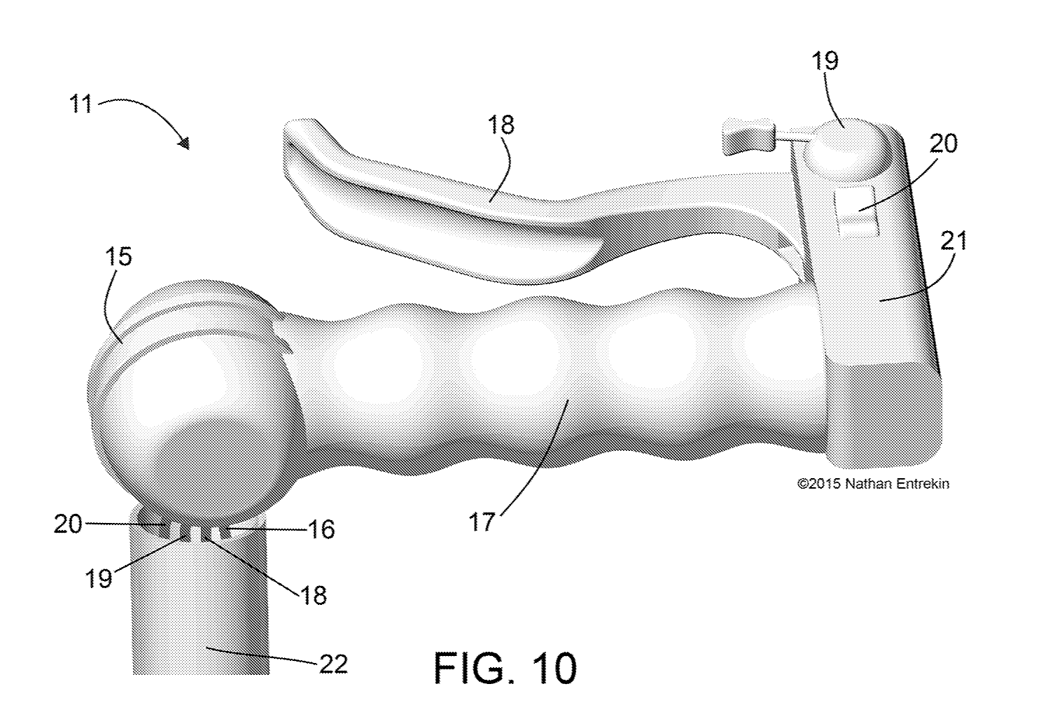

Now referring to FIG. 7, the present embodiment is seen of the steering rod assembly 9, it being connected to the front wheels, running underneath the foot-sliding quad vehicle with tilt-grip steering 1 as FIG. 1-5 has shown. As can be seen in FIG. 7, with intermittent deference made also to FIG. 1-5, the steering rod assembly 9 is parted out as three separate rods, two in front and one in the rear, with a spring tensioner found at middle-front, which serves to bring the front wheels to a normalized straight-bearing position, after a left or right turn is released by the rotatable handle grips of the handle bar and grip assemblies 11 above. Refer to FIG. 8 and FIG. 10 to see the said handle bar and grip assemblies separately. The rods, as given, connect to a right and left side steering brace and arm assembly, which in turn, are secured to the front wheels between the shock absorbers 5 and the brake discs 6. The said steering brace and arm, which are placed at the edge of both sides, is designed to allow for sweeping axial rotation to the right or left or, as aforementioned, to a normalized straight-bearing position. Fastened to the said steering braces and arms exist ball joint components connecting with the aforementioned rods, allowing for this same axial rotation to occur of the assembly as a whole. Again referring to FIG. 8 and FIG. 10 (as well as FIG. 1-5), with steering cables 16 secured within the rotator 15, and running down respectively from both left and right side handle bar and grip assemblies 11, to the said rear rod, at such a position and degree that perpendicular pulling action, by said cables, produces a tugging force upon the rear aspect of each of the respective individual front wheels, right or left turning is enabled. As the said rear rod is pulled from the left side, by the left handle bar and grip assembly 11, the rear section of the left wheel is pulled to the right as its front section veers to the left, which leads the entire vehicle to the left, since the rear rod will also simultaneously act to push the rear section of the right wheel to the right, as its front section veers to the left. As the said two rods of the front are connected together, by the said spring tensioner, the front of the steering rod assembly 9 undergoes a unique stretching force. This force provides the “feel” of controllable elasticity to exist, when turning left or right, based on the degree to which the rotating handle grips 17, moving via the rotator 15, of the handle bar and grip assemblies 11 are engaged by the user, to affect a wide gamut of steering influences, from slight veering to sharp, circling turns. It is noted that the presently disclosed drawings of the connection between the rotator 15 and the shaft 22 is a simplified concept. One embodiment of the said connection includes two solid braces fastened from matching sides of shaft 22 to the sides of the rotator 15. As alluded to previously, this same spring tensioner is responsible for normalizing a straight-bearing position of the front wheels, which does so simultaneously for both wheels. It is noted that the said spring tensioner is capable of such adjustment as to bring the front wheels to relative alignment by its own components within and/or about the steering rod assembly 9. Hence, the steering rod assembly 9 allows the rider to dependently access left or right turns via the left or right handle bar and grip assemblies 11, with such dependence explained by the fact that the said rear rod can only default to one side at one time, insomuch as the winning force of exertion is applied to the turning side, it being left or right. Thus, two simultaneous upward pulls of both handle grips will tend toward one side or the other, just as a bicycle handlebar can only turn one way, even if both hands apply near-equal pulling pressure at the handle grips.

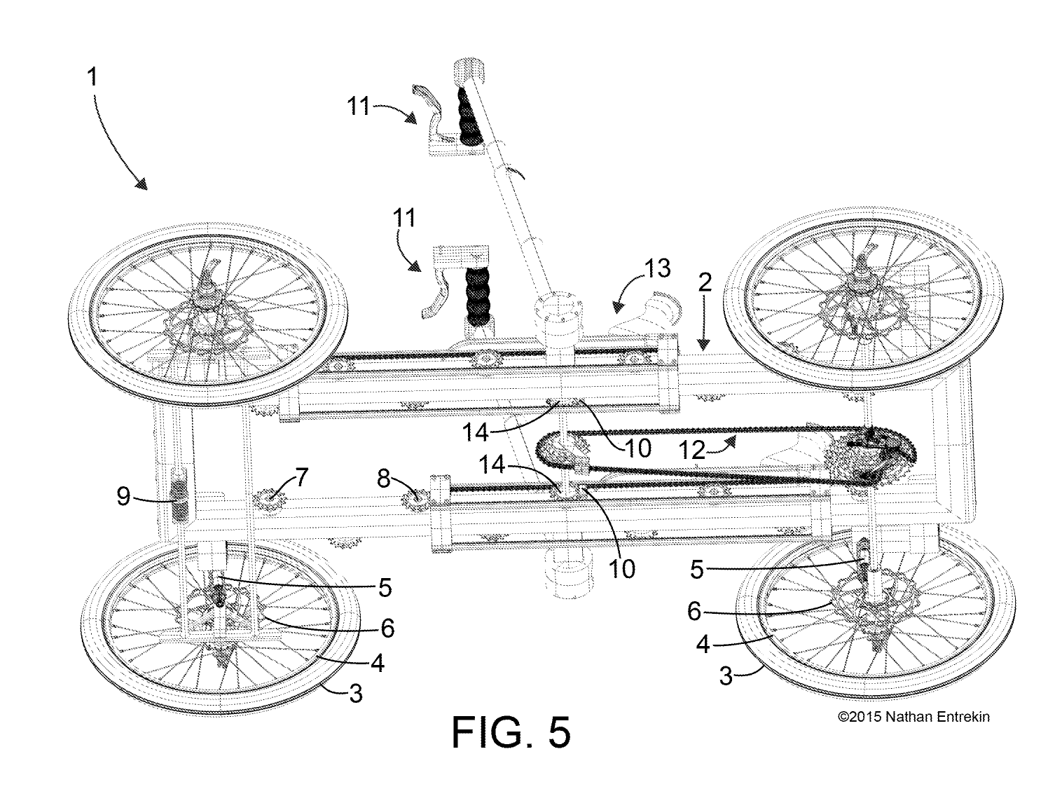

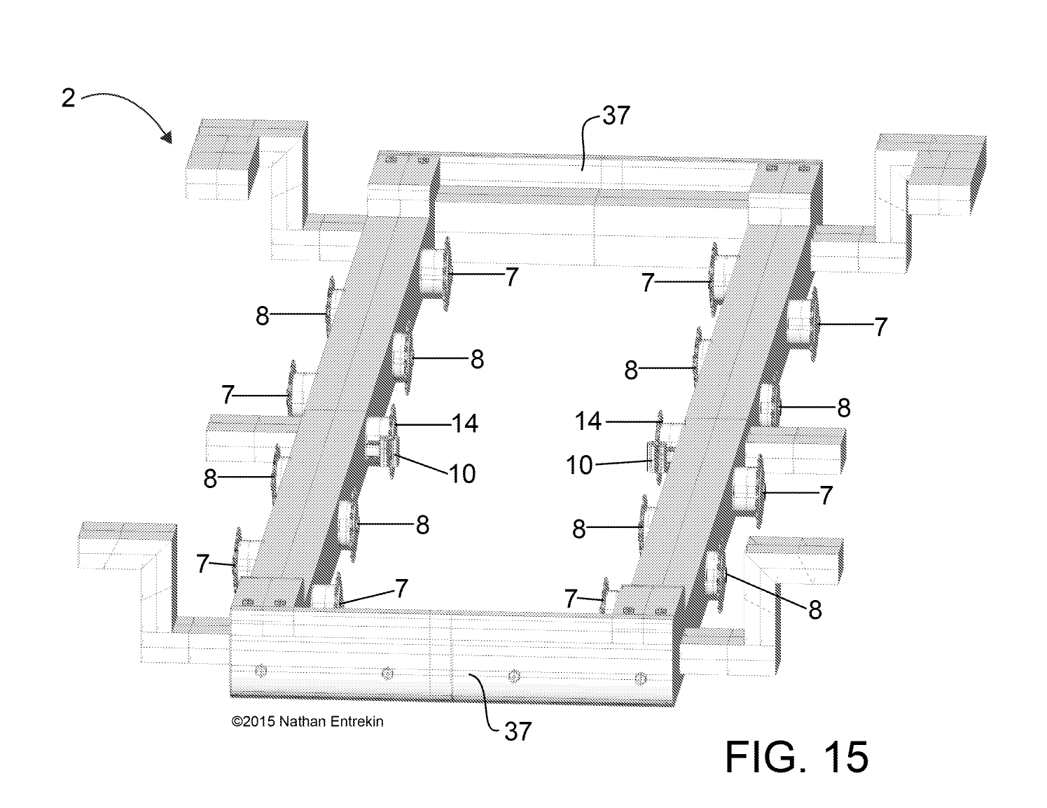

Now referring to FIG. 8 and FIG. 10, as also FIG. 1-5, the bar end brake lever 18, protruding outward sideways from the bar end housing 21, as seen, is recognized as the primary method of stopping the movement of the foot-sliding quad vehicle with tilt-grip steering 1, via the four brake discs 6 and the two sprocket brake calipers 10. It is noted that this type or style of brake lever is customized and the present invention could take advantage of another embodiment as needed. Moreover, there are a number of braking configurations achievable, and it is noted that any chosen method and/or parts and/or components could be employed, other than the disclosed, at the discretion of manufacturing requirements or for any other reasons. For purposes of this disclosure, and referring to FIG. 15 and FIG. 5 in the process, the bar end brake lever 18, at the top of the right side handle bar and grip assembly 11, connects, via its own brake cable 18, to the rear wheels and to the sprocket brake calipers 10 on the right side. Conversely, the bar end brake lever 18, at the top of the left side handle bar and grip assembly 11, connects, via its own brake cable 18, to the front wheels and to the sprocket brake calipers 10 on the left side. Based on this configuration, then, the brake cable 18 of each side, whether right or left, moves down the shaft 22, shaft 24, and base 25 of the handle bar and grip assembly 11, undergoing a split or splice, around the base where it meets the frame assembly 2, and moving outward to the respectively assigned braking equipment. As suggested earlier in the disclosure, there are drawings which do not fully visualize rudimentary components, and brake cable 18 is a case in point, especially as evidenced in FIG. 15 and FIG. 5. Thus, the concept of the entire brake system, as disclosed, relies in this case upon the written logic as explained in regards to the given drawings, where said brake cable 18 is mentioned, but not necessarily fully depicted. This scenario also applies to the other cables to be mentioned in this disclosure. When a rider seeks to apply the brakes, in order to slow or stop the entire vehicle, the foot platform assemblies 13 will tend to freely slide forward, as a product of their momentum from the vehicle's initial velocity to the final desired state, whether slowed or stopped. To properly address this, and in addition to the safety provided by the sturdy handle bar and grip assemblies 11, this effect is compensated, as disclosed, by the sprocket brake calipers 10 on both sides. When a particular braking pressure is applied at the handle grip level, via the bar end brake levers, a relevant and equal pressure is evenly distributed, insomuch as is mechanically achievable, throughout the spliced and paired system of front and rear brake discs 6 and their respective sprocket brake calipers 10. The sprocket brake calipers 10, when applied as disclosed, act to squeeze the engagement sprockets 14, which in turn, work to secure the foot platform assemblies 13, slowing and/or stopping their movement above, in turn, providing sound and intuitive “feel” and braking support for the rider as the vehicle navigates.

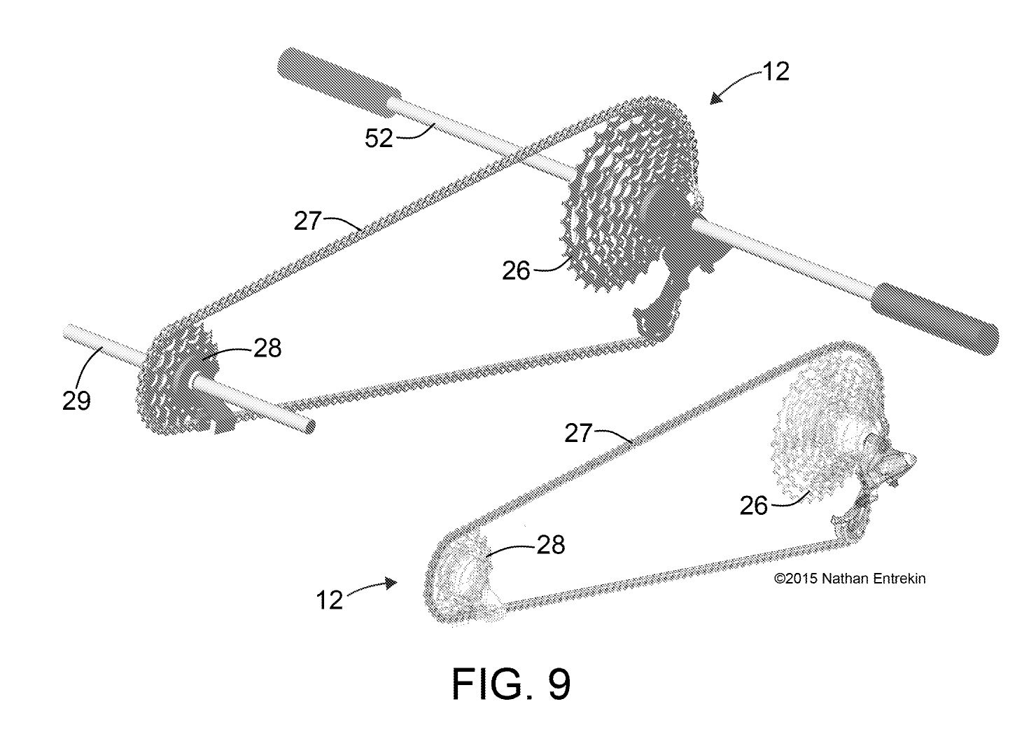

Continuing to refer to FIG. 8, FIG. 10, and FIG. 1-5, as well as FIG. 9, the gear shifting assembly 19, situated on the top and front of the bar end housing 21 as seen, is connected by its own gear cables 19, and begins at the top of each handle bar and grip assembly 11 of the right and left sides. From there, these gear cables 19, run down the shaft 22, shaft 24, and base 25, where they move along the frame assembly 2, in order to connect to their assigned sprocket cassettes of the main chain assembly 12 (see FIG. 9). For the gear shifting assembly 19 of the handle bar and grip assembly 11 on the right side, its gear cables 19 are ultimately assigned to the rear sprocket cassette 26, which will handle the appropriately indexed gear ratios as selected from the right hand level. Similarly, for the gear shifting assembly 19 of the handle bar and grip assembly 11 on the left side, its gear cables 19 are ultimately assigned to the front sprocket cassette 28, where the appropriately indexed gear ratios are called up from the left hand level. Power produced at the said front sprocket cassette is a result of the transference of power by way of the front axle 29, from the engagement sprockets 14 of either side, with the said engagement sprockets being independent of each other. Likewise, when the front sprocket cassette 28 has power produced in the forward motion, its connection with the main chain 27 spins the said main chain around, which in turn, spins the attached rear sprocket cassette 26, which then turns the main rear axle 52 and, thus, the rear wheels spin in the forward motion, moving the entire foot-sliding quad vehicle with tilt-grip steering 1. As can be seen, the entire gear shifting system, as a whole, is essentially the same as any standard 10-speed (or higher) bicycle, which provides the rider with all of the familiarity, maintenance, and conventionality that is expected to exist in such a system. Thus, replacement of parts will be more convenient and suitable as a wide array of resources exists for replenishment. As can be surmised, the rider will be able to select lower and higher gears, as needed, in order to maximize their desired speed levels and overall riding experience. It is noted that any part, element, component, or method of the gear shifting assembly 19, as disclosed, is subject to change at any point in order to accommodate the design, functionality, price, and/or any other factors of the vehicle.

Continuing to refer to FIG. 8, FIG. 10, and FIG. 1-5, with focus on the handle bar and grip assembly 11, the handle bar lock-release button 20 is seen, at the top and middle section of the bar end housing 21. As a way to rotationally adjust the entire handle bar and grip assembly 11, from its base 25, at both right and left sides, the said button, upon depression, would release a locking mechanism within base 25, via its own handle bar lock-release cable 20. The said cable would run from the said button down the shaft 22 and shaft 24 to meet the locking mechanism in base 25. Upon pressing and holding down the said button at its top portion, the said cable would be pulled upward, which releases the locking mechanism, which normally serves to lock and stabilize the whole handle bar and grip assembly 11 within the base 25 at the bottom. It is noted that the concept of such an “accessory button” as this, especially where more room is available at the bar end housing 21 for more buttons or levers, can enable the rider to customize their experience with the vehicle. Moreover, the purpose, function, and/or utility of the button, as disclosed, is subject to change for any reason in the future. It is also noted that the said locking mechanism, as mentioned, exists in the conceptual framework of the utility handle bar lock-release button 20, and is not presently depicted in any of the drawings. As an alternate embodiment of the purpose and/or function of the said button, or by adding another button to the same bar end housing 21, a brake lever lock-and-release button can be had. In this embodiment, the rider can enjoy the ability of “locking in” all brakes, including all four brake discs 6 and the two sprocket brake calipers 10, for the important purpose of entering and exiting the vehicle. It is noted that, although disc brakes are preferred, other braking mechanisms, such as traditional bicycle caliper brakes, can be employed in the operational of the vehicle. By holding the brake lever (of any or both sides), then pressing down at the bottom portion of the button (as given on the bar end housing 21), the assigned brakes of that particular brake lever will be held in braking position, locking in the brake levers to a pulled position. The stability provided by this action can be realized when a rider desires complete stoppage of the vehicle, while negotiating entry to each foot platform, or when brought to a stationary position on an incline, such as a hill or a mountain. Referring to FIG. 8, the handle bar shaft lock 23, serves as a height adjustment tool for each of the handle bar and grip assemblies 11. One embodiment allows for the unloosing of the said handle bar shaft lock, with a few counterclockwise turns, such that the shaft 22, and all components above it (i.e. handle grip 17, brake lever 18, etc.), are able to shift up or down freely, along the shaft 24, to meet the height needs of the rider. Then, with a few twists at the desired height level, the entire handle bar and grip assembly 11 will be secured. Another embodiment allows for height adjustment in the same manner as the aforementioned, except in this case, custom-drilled holes in the shaft 22 gives the rider more exactness in adjustment, such that both handle bar and grip assemblies 11 can more readily be aligned across the top, without leveling disparities.

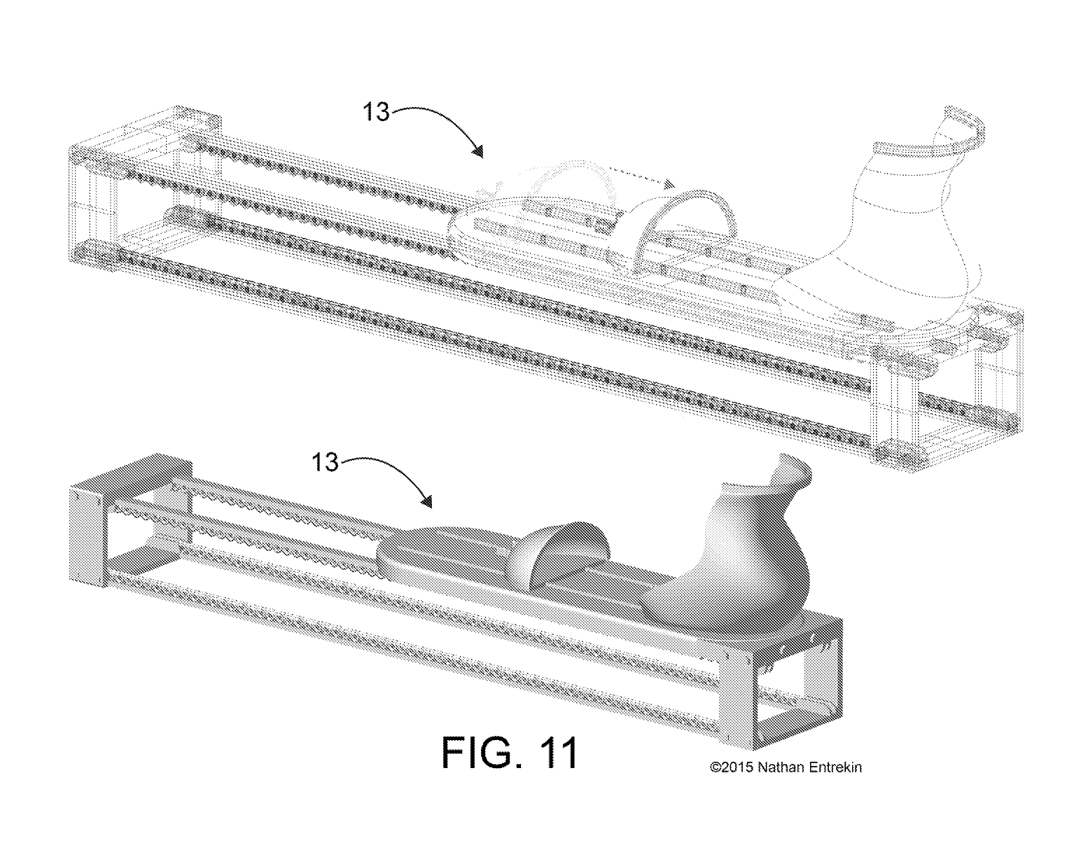

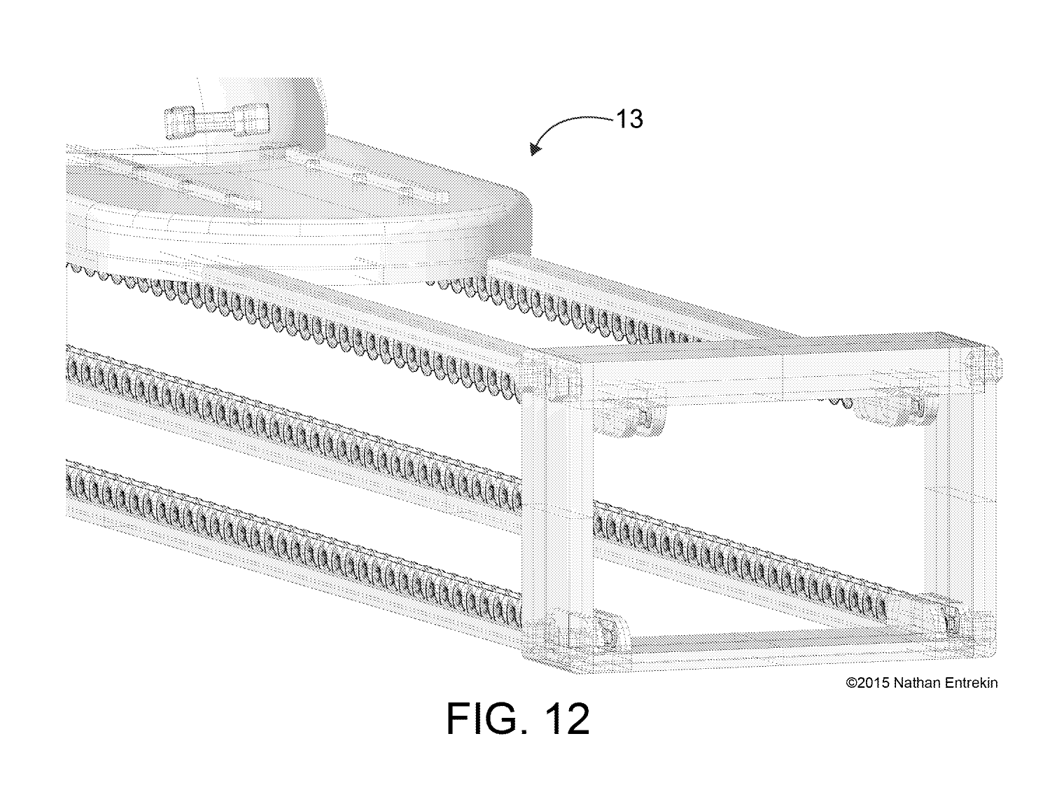

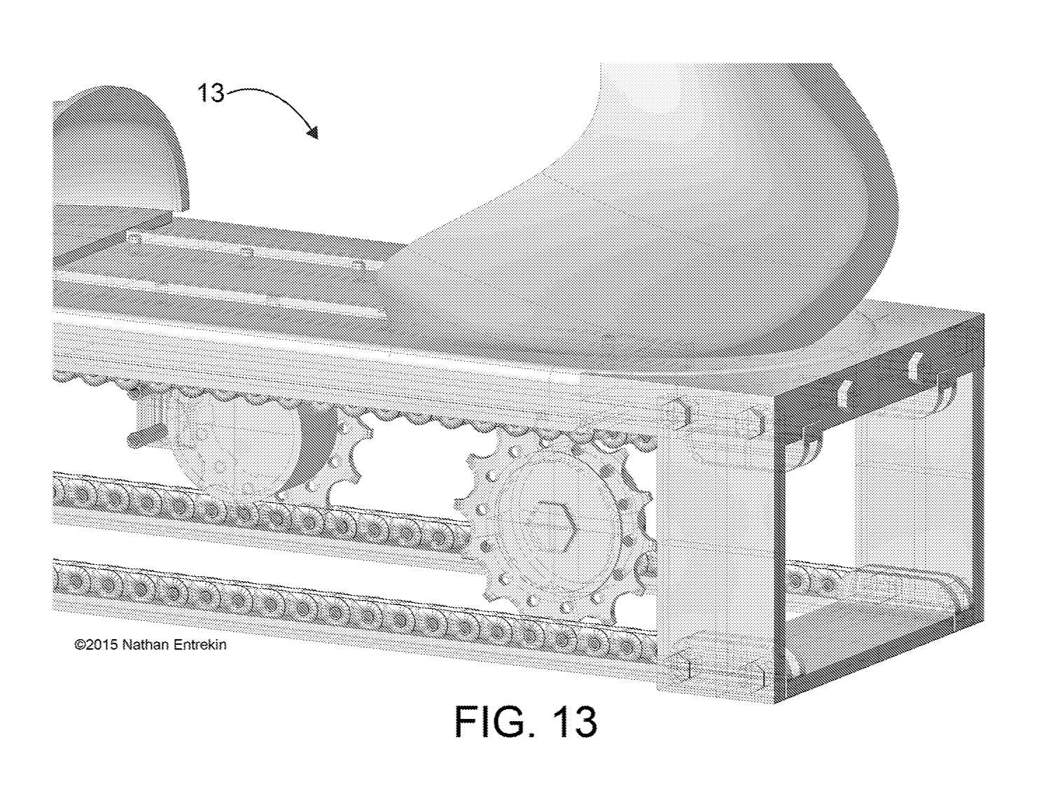

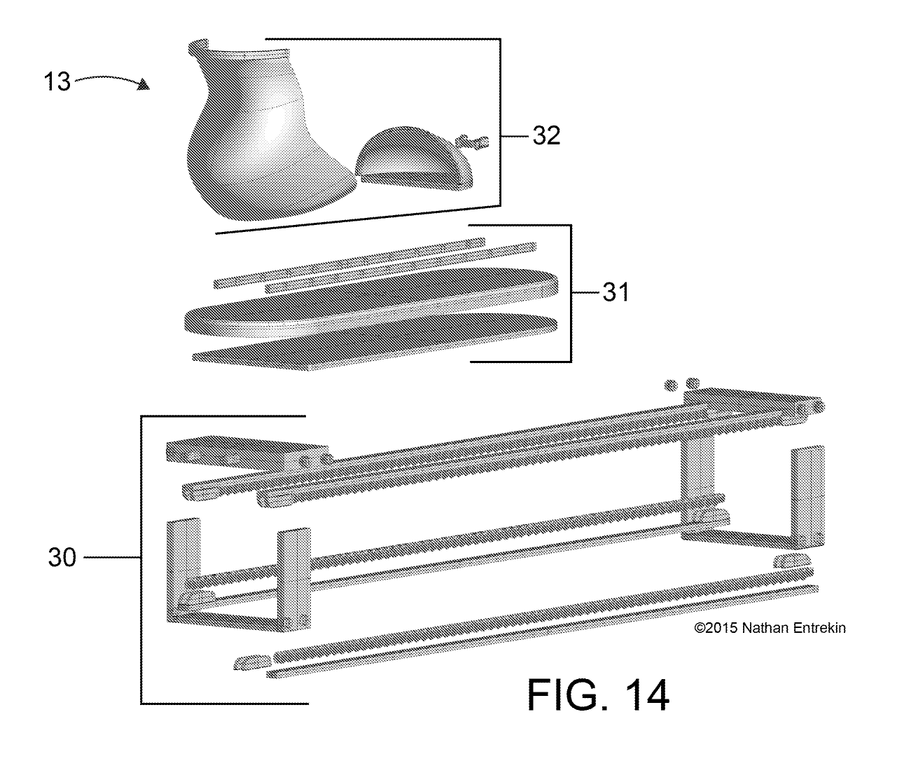

Now referring to FIG. 11-14, with reference also to FIG. 1-5, the foot platform assembly 13 is an integral component group of the entire present invention, and it is noted that there exist other embodiments than that presently disclosed. This component group is a unique feature, lending to the universality of the present invention, since humans of a wide variety of ages have the chance to ride, having such accessibility and customization as given. The foot platform assembly 13 moves back and forth along the side lengths of the frame assembly 2, via the affixed sprockets as mentioned before in this description. The rider is ultimately responsible for vehicle speed through the personal choice of intensity, form, and stride (not to mention proficiency with gear shifting). As seen in this disclosure, there is a chain stick assembly 30 having four chain sticks secured within a system of reinforced plates and bolts, a platform group 31 with toe block adjustment rails, primary platform, and reinforcing plate, and a shoe binder 32 with a separate heel block and an adjustable toe block. The estimated length of the foot platform assembly 13, as a whole, is determined to be no less than 24 inches and no more than 40 inches, where the four chain sticks are expected to have the highest contact with the engagement sprockets while in action, and yet still allow for comfortable range of motion along the sides of the frame assembly 2. In addition to these human factors conditions and considerations, the length of the said foot platform is an important determinant in the overall stability of the motion and the feet themselves, since the free-spinning sprockets 7 and 8, and engagement sprockets 14, are interspersed at particular distances which require adequate footing and surface area contact for best performance. Focusing on chain stick assembly 30, the four chain sticks will not only be welded lengthwise all along support plates, but be reinforced to the large, boxed steel plates at each end via welded buttresses at the top and bottom. It is noted that the entire foot platform assembly 13 could contain, or not contain, parts, elements, or components which may or may not be utilized, including, but not limited to, methods and/or material types within manufacturing, but which should hold deference as to the conceptual nature of the said foot platform assembly. For example, the bolts of the chain stick assembly 30, by default, indicate the ability to be assembled or disassembled and provide a rigid and secure structure in its fastened state. As seen in the disclosure, the platform group 31 is fastened to the chain stick assembly 30 in a welded manner, or by another more suitable method(s) discovered in the manufacturing process. Focusing on the shoe binder 32, the heel block is to be a fixed element, where shoe or foot bracing is primarily handled by the adjustable toe block piece. This said shoe binder will be fastened to the primary platform of the platform group 31, which in turn, is fastened to the reinforcing plate, by a series of bolts and/or a manner of welding or other suitable method using appropriate smaller parts. Clearly in the spirit of this present embodiment, then, using the said shoe binder should necessitate the use of the brake levers 18, in order to assist in entering and exiting the vehicle in a safe and stable manner. As suggested earlier, the rider can take advantage of the alternate embodiment of the brake lever lock-and-release button, in order to affect a “locking” brake position upon the entire vehicle, making for quicker, easier, and safer mounting. Considering its affinity to customizability, alternate embodiments of the present disclosure of the shoe binder 32, as placed atop the foot platform assembly 13, are possible. One embodiment could replace the said shoe binder of both sides with a person's own set of snowboard shoe binders, or even those of snow skis or sand boards. Another embodiment might replace the said shoe binder with waterski foot binders, when a rider feels the need to travel barefoot atop the vehicle. Yet another embodiment might disregard any “binding” per se, opting for a much easier generic platform whereby a rider could simply place the feet atop the said foot platform assemblies, executing backward thrusts simply by body weight. Thusly, it is recognized that providing a more universal or wide-reaching approach to securing shoes, feet, ankles, and/or lower legs is always optimal for the present invention, especially as it opens a pathway for user customization. It is also noted that the said foot platforms, as disclosed, are subject to any number or manner of modification(s) to their rolling mechanisms, such that wheels, ball bearings, chain/sprocket assemblies, and/or any other type of equipment, material, or implementation method(s) be used for that purpose.

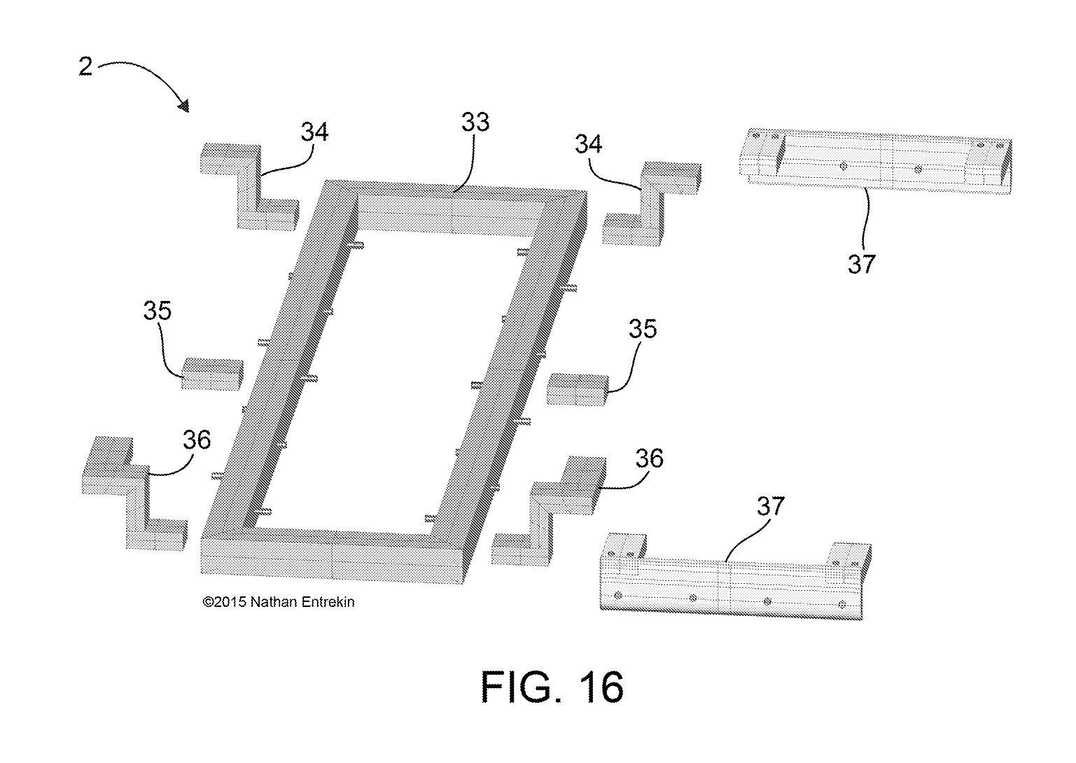

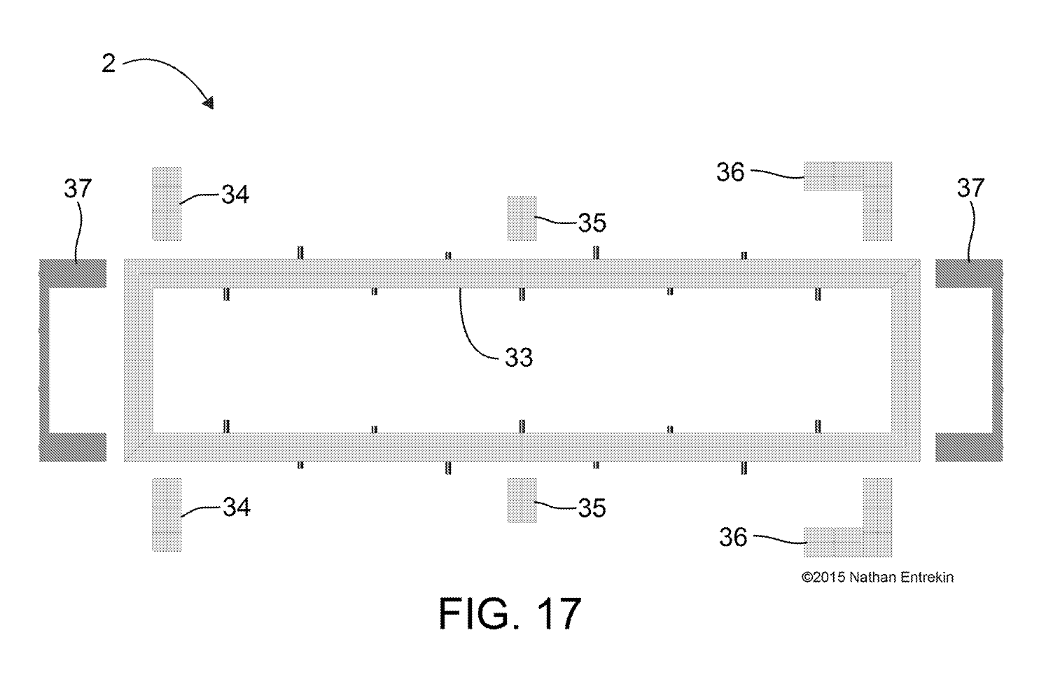

Now referring to FIG. 15-17, the rectangular frame assembly 2, running approximately 65 inches in length and approximately 20 inches in width, is shown in its essential form, with free-spinning sprockets 7 and 8, engagement sprockets 14, sprocket brake calipers 10. Note that removal of the aforementioned sprockets from frame assembly 2 reveals sprocket studs, which have been welded, or fastened thereto by another preferred method, to the skeletal frame 33. At the lengthwise midpoint of the said skeletal frame at each side, are the handle bar support beams 35. At the front endpoint of the said frame, at each side, are front suspension columns 34, while at the rear endpoint of the said frame, at each side, are rear suspension columns 36. Secured to the skeletal frame 33, and thus by default, to frame assembly 2, at the front- and rear-facing endpoints, by certain bolts or other preferred materials/methods, are frame bumpers 37, which also have two stoppers each affixed to the top against each of these bumpers (i.e. a bumper/stopper combination). The stoppers function to block the foot platform assemblies 13 from running off the frame, maintaining an operational limit, and can also be seen as visual guides for riders as they slide back and forth. Any and/or all components, up to and including the frame itself, as presently disclosed, are subject to any manner of future revisions, as to type, size, shape, material makeup, dimensions, length, width, thickness, orientation, function, method of production, and/or any other aspect.

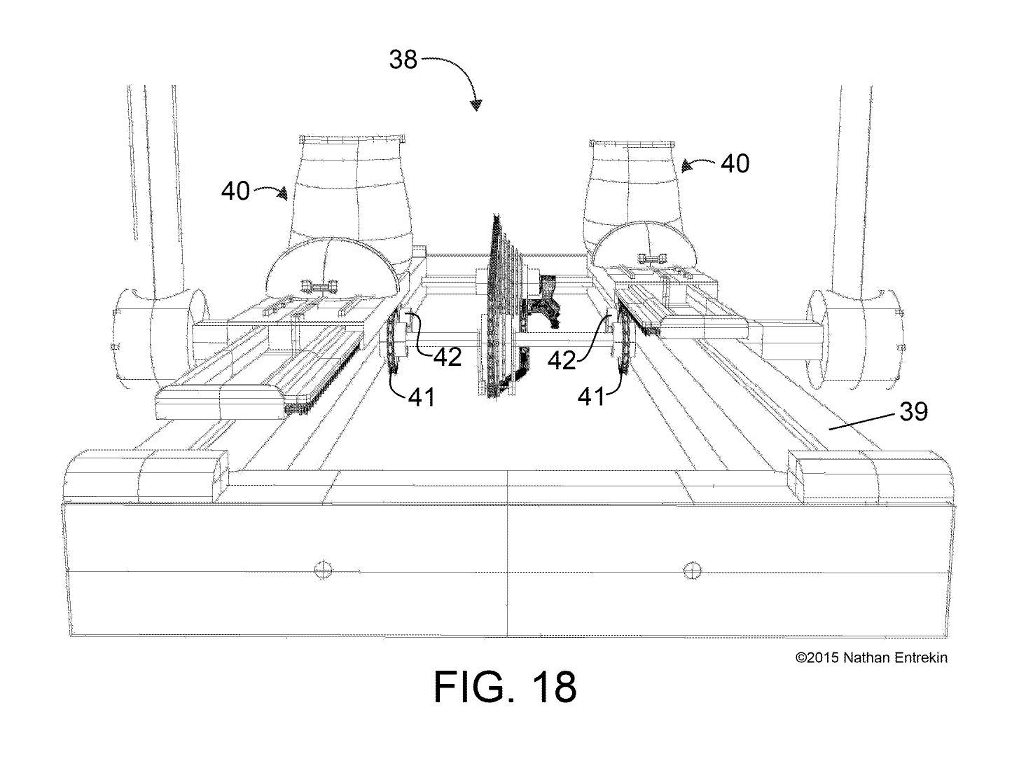

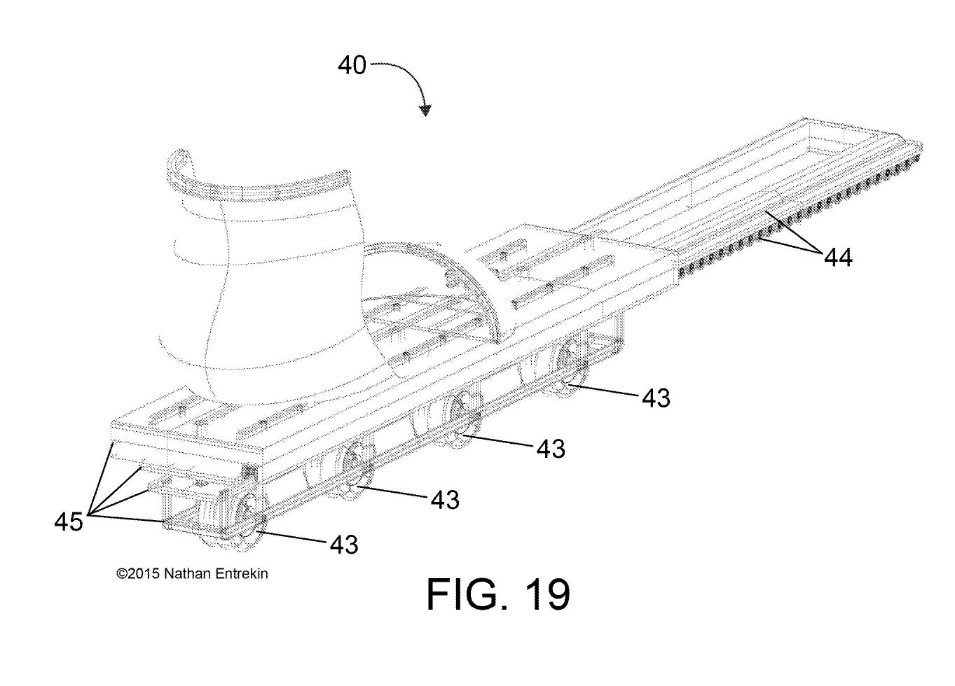

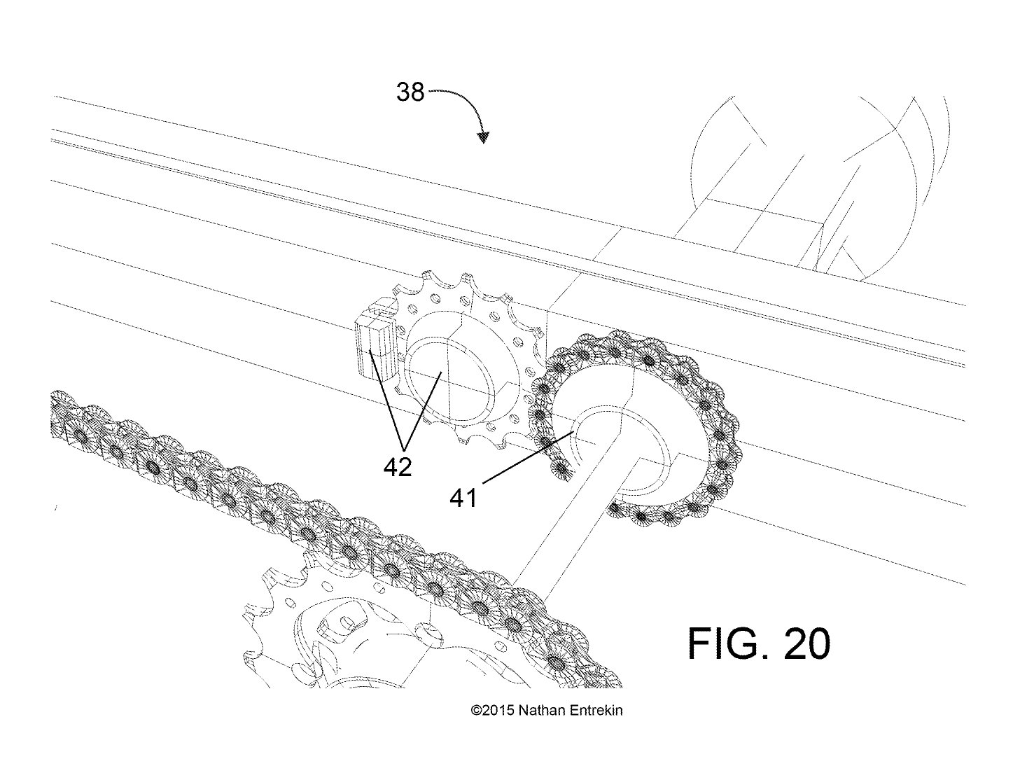

Now referring to FIG. 18-20, an alternate embodiment of the foot-sliding quad vehicle with tilt-grip steering 38 is shown, with specific attention and disclosure of the frame 39, an foot platform assembly 40, an sprocket engagement system 42, depicting the engagement sprocket and sprocket brake calipers, and a chained sprocket 41. As can be seen, the said foot platform assembly 40, exists as a type of hybrid “roller blade,” with the components of platform group 45 intended to fasten together not only the shoe binder above, but also to hold the roller wheels 43 and the single chain stick and housing 44 together as well. The approximate length of the foot platform assembly 40 is, as a whole, determined to be no less than 24 inches and no more than 40 inches. As seen, this embodiment takes advantage of the frame 39, itself, where the said foot platform assembly can be inserted to run back and forth in its confined space. A predetermined slit cut at the top-middle of the said frame runs along from the front end to approximately 12 inches from the rear end, and there are components, as shown, which assist in stopping or blocking the said foot platform assembly, of both sides. The accompanying single chain stick and housing 44 rolls along the sprocket engagement system 42, which functions to allow for free spinning in the inactive direction, and also engagement between the regular sprocket and a chained sprocket 41 in the active direction, as well braking via the sprocket brake calipers as seen. When engaged, the regular sprocket acts to turn backward, with the chain motion, interacting with the chained sprocket, which in turn, produces forward motion, which then allows for the connected axle to spin the connected sprocket cassette, following a similar logic as the aforementioned, originally-disclosed embodiment.

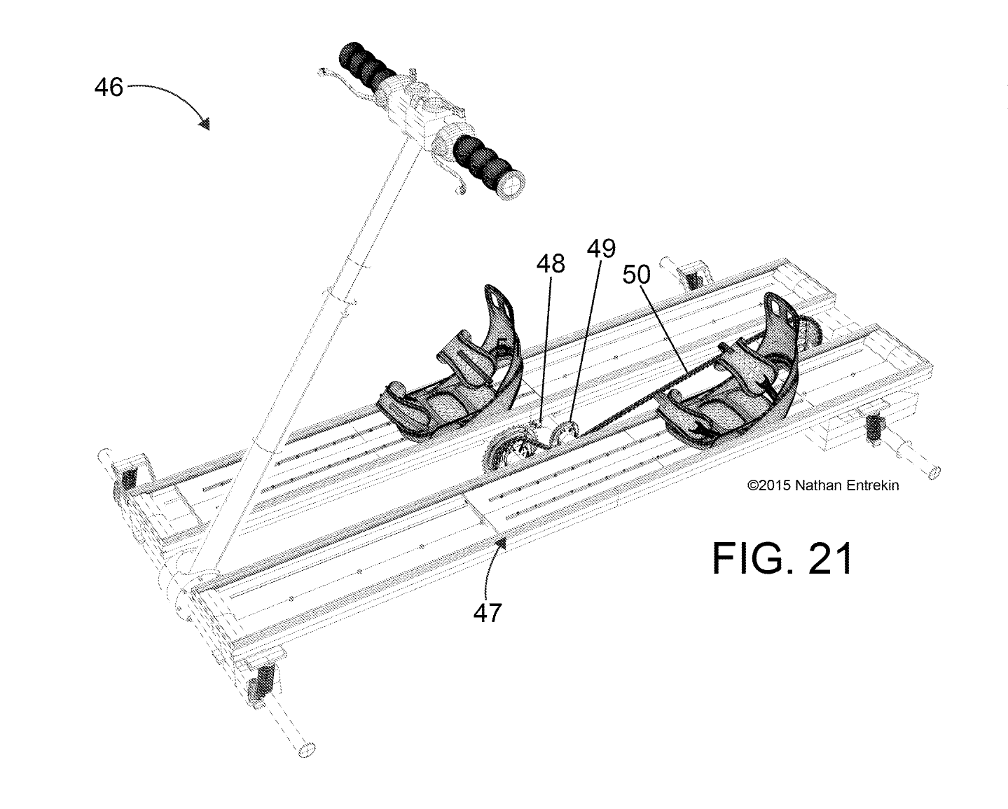

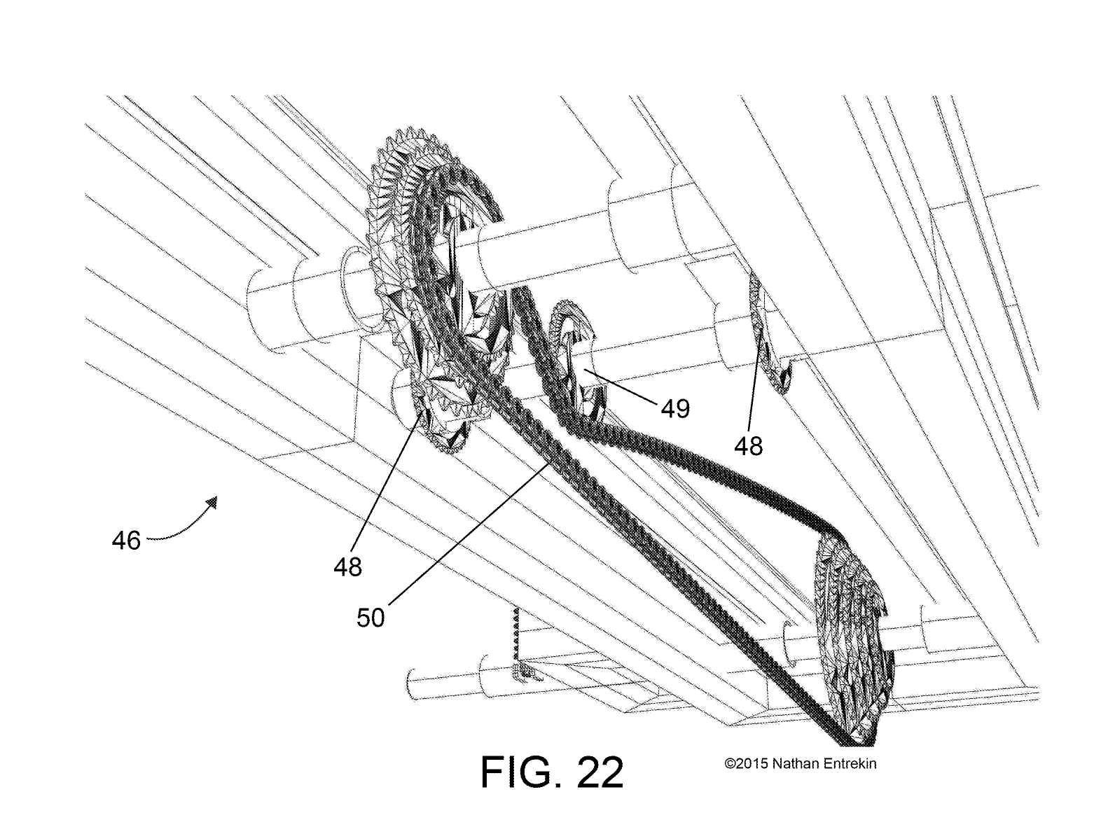

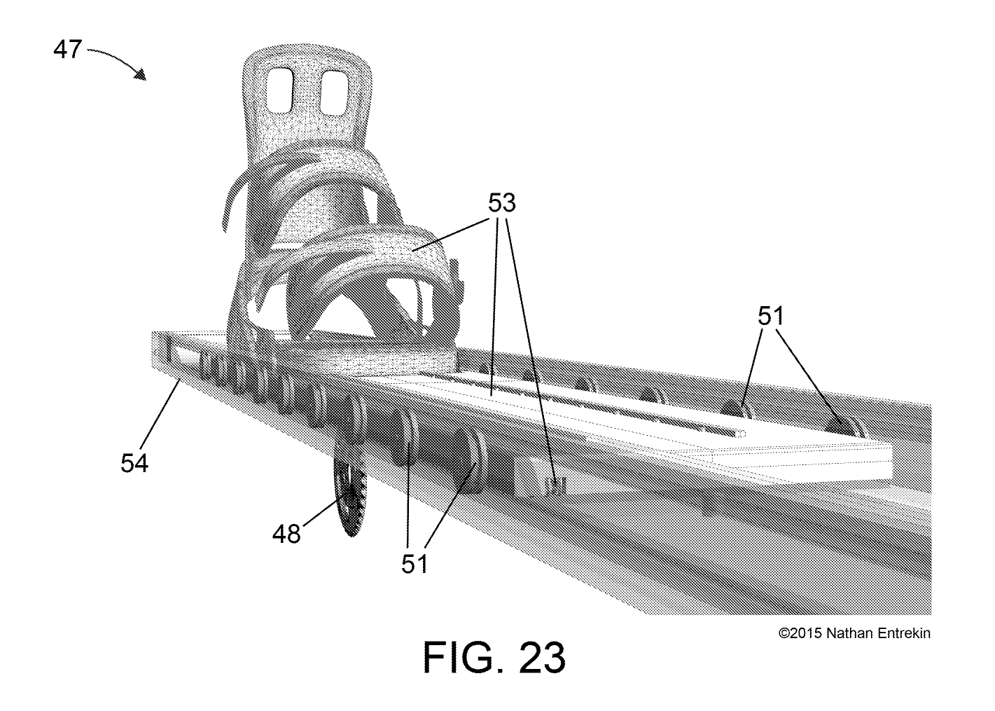

Now referring to FIG. 21-23, an alternate embodiment of the foot-sliding quad vehicle with tilt-grip steering 46 is shown, particularly at the regions of the foot platform main unit 47, engagement sprockets 48, reverse motion sprocket 49, and main chain 50. The two engagement sprockets 48 are activated when the said foot platform assemblies roll backward over the said engagement sprockets, causing the connected axle to turn the reverse motion sprocket 49 backwards. The said reverse motion sprocket is positioned in such a way above the main chain 50, by the said connected axle, as to cause the said main chain to spin forward around the depicted front and rear sprocket cassettes. The foot platform main unit 47 encompasses more of a whole concept than the sum of its parts, where is seen a fray-like rail housing unit 54 (sometimes known as T-track), on both sides, which acts as the vertical limiter to its respective foot platform assembly 53. It is furnished with adjustable stoppers at both ends for catching and protecting from extreme foot strides. The embodiment of the foot platform assembly 53, as seen in FIG. 23, includes a generic shoe binder with minimum length of 24 inches and maximum length of 40 inches, an adjustable primary platform, and an embedded chain stick at the inward-facing sides, at about 1 inch from the edge. The chain stick rolls over the engagement sprocket 48 in the act of transferring power to the main chain assembly, similarly as previously disclosed in the original embodiment. Extending from within the adjustable primary platform to both sides of each rail housing unit 54, exists a series of five to ten mini-roller wheel and axle sets 51 (nine are depicted in this disclosure), spaced equidistantly along the length, with certain expected components not particularly available in the drawing, but most viable in the conceptual sense. As such, and with respect to any and/or all of the components of this alternate embodiment, as disclosed, are subject to change in terms of type, size, dimensions, orientation, material makeup, wheels, bolts, methods of construction, and/or any other aspect.

The foot-sliding quad vehicle with tilt-grip steering, as described above, therefore, provides a four-wheeled, standing and sliding riding experience which deviates from conventional cycling, alleviating the need for a rider to be balanced on two wheels or be concerned about inadvertent tipping from 3-wheeled vehicles. With the advent of the special braking system, which accounts for the stoppage, not only of all four wheels, but the foot platforms as well, riders will be safer upon entry, exit, and at times of slowing and/or stopping in general. As well, the handle bars and grips will be instrumental in supporting riders, at most human height levels, while negotiating various speeds, terrains, and conditions. Measurements of the wheel base and the width and length of the vehicle, itself, are based on the principle of the “golden rectangle,” which follow the premise of geometric stability and is highly-valued in form factor design. With a fully independent suspension system and the flexion characteristics of the human leg, ankle, and foot, this quad vehicle offers superior performance in a variety of terrains and conditions, up to and including wet roads, gravel, snow, light mud, forests, deserts, steep hills, dirt, sand, and so forth. Moreover, as this quad vehicle tends to elicit a myriad of human exercise attributes, including, but not limited to, core strength training, cardio conditioning, physical endurance, stamina, and stretching, especially in a high-intensity mode of operation, results could be extremely favorable compared with traditional cycling. Of course, transportation would be one of the primary uses and it is expected that the majority of riders will hail from suburban and urban settings, making this a powerful “green” vehicle for the environmentally conscientious. The innovative approach to navigating by the tilt-grip steering mechanism lends to a fun way of moving about the world. Riders can rely on responsive and intuitive handle grips, replete with built-in braking, shifting, and turning gear, and accessible at the desired body and hand positions. The capability for multiple accessory buttons and/or levers, also at the fingertips, appeals to the open source crowd, novice modifier, or professional enthusiast alike. It is expected that this quad vehicle will handle heavy loads, perhaps up to 350 lbs. or more, depending on metal alloy strengths, component quality, and so forth.

There are a number of modifications and alternate embodiments of this present invention, as has been disclosed, that are, and will be, apparent to those skilled in the art, and that serve to expand upon its different uses and aspects. Based on the need to sufficiently equip the present invention with the required abilities to avail its proper functionality within its targeted terrain(s), climate(s), and/or condition(s), one such embodiment replaces the wheels, altogether, with some variety of snow track(s), perhaps similar to a snow mobile, which could allow for travel in a snowy climate. In another embodiment, the present invention might be altered, in such a way, as to avail movement over a body of water, with rudder controls, floating tires, water-based material(s), and/or other accessories, implemented in any way, and operated by any method. In fact, the given foot platforms, as disclosed, could be modified in such a manner as to render aquatic thrust via hinged fin paddles, positioned below each foot platform, which engage in the backward motion of the feet in order to push water, hence providing forward thrust of the whole vehicle. Such customization of the present invention paves the way toward a more amphibious experience for the rider and is sure to turn heads. Considering possible size variations, and in light of human factors, safety, and operational issues and values, different-sized embodiments of the disclosed are achievable. Thus, the creation of a children's version, or any other size variant, could also complement the adult version, of which the latter exists as seen in the provided specifications and drawings of the disclosure. It is also recognized that the native format of the present invention, being innately adjustable at key points, can effectively bridge the gap for universal use amongst adults and children. Considering the functionality and capabilities of the present four-wheeled invention as disclosed, there could be embodiments which operate completely with one, two, and/or three wheels. Any such modifications, as the aforementioned, are retained within the same category of utility with respect to the original present invention, including all revisions to any or all aspect(s) or part(s) of the said present invention. Yet another embodiment could be altered and/or enhanced, to such a degree, in order to more adequately accommodate the physically disabled, injured, or even hospitalized persons, through certain additions, reductions, and/or other changes to the present invention, which would be directly beneficial to these specific user audiences. In fact, considering certain configurations, it is also noted that the present invention may be utilized as a therapeutic or rehabilitation device which assists users in exercise, leg movements, and/or other training and coordination activities.

Continuing alternate embodiments of the present invention as disclosed, another embodiment considers the “forward-only” motion of the present invention, and would allow for reverse vehicular motion, by making the necessary modifications to the present invention, as required, to achieve said reverse vehicular motion and add value to the overall riding experience. In this same embodiment or another, there could also be some switching mechanism in the drive system to “reverse” actual foot sliding motions, such that forward sliding engages propulsion and backward sliding is freewheeling and/or engages backward movement of the vehicle. Another embodiment could have one or more seats or benches implemented and secured at certain areas, in the fore and/or aft sections, or even at the sides, with adjustable characteristics allowing for seated or non-seated operation; thus, a rider could operate in multiple modes, whether choosing to ride the present invention normally while standing (i.e. seat is dormant) or ride/coast while sitting (i.e. seat is active), with ability to adjust the seat height and/or retract/remove/store the said seat on or off the present invention itself. This might prove useful throughout longer journeys, when cruising down stretches of downhill inclines, or even when just relaxing at a baseball game, concert, festival, or a holiday celebration. It is recognized that this same embodiment could have multiple seats installed and used, which could allow for multiple riders and/or passengers; in an example of this arrangement, there could be a rider in the aft position providing power/control of vehicular movement, whilst a passenger is seated in the front orientation. In a similar embodiment using the aforementioned seat(s) on the vehicle, specialty application(s) of the present invention as disclosed, can be had for people in sporting events, such as for a human-powered golf caddy vehicle, for use by football or soccer coaches, or any other application where ‘faster-than-running’ speed is needed or when batteries are not needed, or for any other reason. In another embodiment, the present invention could be modified to such a degree as to allow for tandem riding, which would likely integrate the addition of an extra set of foot platforms and/or shoe binders, as well as handle bars/grips, and any other parts or materials necessary, in any conceivable arrangement, in order to accommodate more than one person on the single present invention while riding. Thus, two persons could ride at the same time on the present invention as they actively engage vehicular motion, steering, and/or other operations together. Furthermore, considering the shape and structure of the vehicle frame, and its constituent parts, as disclosed, it is also possible to allow inactive riders to “hop on” the vehicle in the front, back, and/or any other convenient location. Such potential multi-rider experiences are reminiscent of the proverbial “pump on the handle bars” technique of allowing others to ride on a human-powered vehicle, whether assisting with any navigation controls or not. As an exciting entry to personal motorized travel, another embodiment allows for the present invention, through certain modifications and/or additions and/or reductions, to be equipped with a motor or engine, whether of gas, electric, or any other variety, as a source of main, auxiliary, supplemental, and/or augmented power.

Continuing alternate embodiments of the present invention as disclosed, in another embodiment, the present invention could be made to be stored, of itself in a more efficient, effective, and convenient manner than is currently portrayed in the specifications and drawings, with the potential ability to be folded at certain areas or points on the present invention, and/or by the inclusion and use of specialized “parking” devices, stoppers, hangers, and/or any other item made with the intent to store the present invention in a garage, storage shed, and/or any other building or place. Likewise, in such an embodiment as the aforementioned, the present invention could be made to be transportable, by way of car, truck, van, or other “carrier” vehicle or system, and that, by the design and use of holding structure(s), device(s), and/or any other manner, method, or equipment suited for that purpose. In yet another embodiment, the present invention can take advantage of self-installed locking mechanisms, for the purpose of securing the entire vehicle, thereby helping to prevent against theft and/or any other malicious intent. Following the pattern of lock-and-release mechanisms, as alluded to throughout the disclosure, another embodiment involves the use of a convenient safety release button, at the handles and/or at the foot platform level, that allows for quick vehicle abandonment, if the need arises. The shoe binder, in this case, might be under some type of spring pressure where, upon securing (i.e. lock in) of the shoes to the platform, the said safety release button can be accessed to instantly open the adjustable toe block, in the event of an “emergency exit” situation, where jumping off the vehicle quickly and safely is desired. In terms of a non-related embodiment, standing-based human motion via similar foot platforms, as disclosed in the present invention, could produce an interesting offshoot of non-electrical-based human movement amongst different environments. For example, within certain public facilities or malls or other centers, where a stronger ‘green’ presence of environmental sustainability exists, there could be horizontal or vertical (or even straight vertical) escalators that are human-powered, again by similar methods as brought to bear by the said foot platforms of the disclosed invention. In another embodiment, the present invention can take advantage of modification(s) to any and/or all of its handle bar structures, from base to top, including replacement, modification, removal, revision, and relocation of all attached parts (i.e. handle grips, brake levers, gear shifters, rotating/steering spindles, adjustment knobs, levers, cables, etc.). Over the course of time, and as demand increases, custom products related to, and/or made for, the foot-sliding quad vehicle with tilt-grip steering, could come into existence. This could avail alternate embodiments of the present invention, and its disclosure, to include such things as sprocket cassette and/or chain covers, frame assembly trim packages, custom umbrellas, covers, carrying baskets and cases, compartments, radio/stereo/smart phone holders, and/or other cosmetic adaptations, protective equipment, and/or general enhancements for the benefit of riders. Such alternate embodiments are all welcome additions to the new family of this human-powered machine.

What is claimed is:

1. A human-powered, four-wheeled vehicle comprising:
a frame assembly having squared frame tubing that accommodates the width of an average adult human in the standing position;
two sliding foot platforms, made as an assembly of four chain sticks, bolted together to an adjustable shoe binder, and secured at said frame tubing, running at the lengthwise sides;
two adjustable handle bar and grip assemblies, placed at side midpoints of the said frame, with handle grips, bar end brake levers, gear shifters, and custom accessory buttons.

2. The human-powered, four wheeled vehicle of claim 1, wherein the said handle grips act can tilt, or rotate, laterally from a level orientation to an upward orientation, causing left or right turning to occur.

3. The human-powered, four wheeled vehicle of claim 1, wherein the said frame tubing has a rectangular structure, with suspension columns at all four ends, and affixed with a front and rear bumper/stopper combination at front and rear.

4. The human-powered, four wheeled vehicle of claim 3, wherein are fastened sixteen free-spinning sprockets and two inner bicycle-grade 10-speed engagement sprockets, spread equidistantly along the inner and outer lengthwise sides, all of which provide secure footing and power transfer to the rear wheels.

5. The human-powered, four wheeled vehicle of claim 3, wherein each of the said four suspension columns connect to front and rear shock absorbers, brake discs, wheels, and tires.

6. The human-powered, four wheeled vehicle of claim 5, wherein a steering rod assembly, with a spring tensioner connects the controls turning of the front wheels and tires.
